(19) United States
(12) Patent Application Publication
(10) Pub. No.: US 2015/0361288 A1
(43) Pub. Date: Dec. 17, 2015

(54) SACRIFICIAL COATING COMPOSITIONS FOR INDIRECT PRINTING PROCESSES

(71) Applicant: XEROX CORPORATION, NORWALK, CT (US)

(72) Inventors: Guiqin Song, Milton (CA); Gordon Sisler, St. Catharines (CA); Brynn Dooley, Toronto (CA); Rosa M. Duque, Brampton (CA); Marcel P. Breton, Mississauga (CA); Suxia Yang, Mississauga (CA); Frank Ping Hay Lee, Oakville (CA); Michael J. D'Amato, Thornhill (CA); Aurelian Valeriu Magdalinis, Newmarket (CA); Biby Esther Abraham, Mississauga (CA)

(21) Appl. No.: 14/306,750

(22) Filed: Jun. 17, 2014

(51) Int. Cl. C09D 129/04; C08K 5/06; C08K 5/053

(52) U.S. Cl. CPC C09D 129/04; C08K 5/053; C08K 5/06

(57) ABSTRACT

Disclosed herein are sacrificial coating compositions comprising at least one polymer chosen from polyvinyl alcohol and polyvinyl alcohol copolymers, a wax emulsion comprising at least one wax, at least one surfactant, at least one hygroscopic agent, and water. In certain embodiments, the at least one wax in the wax emulsion has a melting point approaching but just below the ink transfer temperature, such as, for example, a melting point ranging from about 50° C. to about 150° C. Also disclosed herein is a blanket material suitable for transfix printing comprising a sacrificial coating composition, as well as an indirect printing process comprising a step of applying a sacrificial coating composition to a blanket material.

### TECHNICAL FIELD

The present disclosure relates to sacrificial coating compositions for use with indirect printing processes, such as inkjet printers, for example sacrificial coating compositions for use on an intermediate transfer member of an indirect inkjet printer.

### BACKGROUND

In aqueous ink indirect printing, an aqueous ink is jetted on to an intermediate imaging surface, which can be in the form of a blanket. The ink may be partially dried on the blanket prior to transfixing the image to a media substrate, such as a sheet of paper. To ensure excellent print quality, it is desirable that the ink drops jetted onto the blanket spread and become well-coalesced prior to drying. Otherwise, the ink images may appear grainy and/or have deletions. Lack of spreading can also cause missing or failed inkjets in the printheads to produce streaks in the ink image. Spreading of aqueous ink may be facilitated by materials having a high surface free energy, and therefore it is desirable to use a blanket having a high surface free energy to enhance ink spreading.

However, in order to facilitate transfer of the ink image from the blanket to the media substrate after the ink is dried or partially dried on the intermediate imaging surface, a blanket having a surface with a relatively low surface free energy is preferred. Rather than providing the desired spreading of ink, low surface energy materials tend to promote “beading” of individual ink drops on the image receiving surface.

Thus, an optimum blanket for an indirect image transfer process should tackle both the challenges of wet image quality, including desired spreading and coalescing of the wet ink, and the image transfer of the dried or partially dried ink. The first challenge—wet image quality—prefers a high surface energy blanket that causes the aqueous ink to spread and wet the surface. The second challenge—image transfer—prefers a low surface energy blanket so that the ink, once dried, has minimal attraction to the blanket surface and can be transferred to the media substrate. Those two conflicting requirements can make the whole process of wetting, release, and transfer in indirect printing processes very challenging.

In addition to indirect ink jet printing, offset lithography is a common method of printing today and, having similar challenges, is contemplated for the processes and compositions disclosed herein. In a typical lithographic process, a printing plate, which may be a flat plate, the surface of a cylinder, or belt, etc., is formed to have “image regions” formed of hydrophobic and oleophilic material, and “non-image regions” formed of a hydrophilic material. The image regions are regions corresponding to the areas on the final print (i.e., the target substrate) that are occupied by a printing or marking material such as ink, whereas the non-image regions are the regions corresponding to the areas on the final print that are not occupied by said marking material. The hydrophilic regions accept and are readily wetted by a water-based fluid, commonly referred to as a fountain solution (for example comprising water and a small amount of alcohol as well as other additives and/or surfactants to reduce surface tension). The hydrophobic regions repel fountain solution and accept ink, whereas the fountain solution formed over the hydrophilic regions forms a fluid “release layer” for rejecting ink. Therefore the hydrophilic regions of the printing plate correspond to unprinted areas, or “non-image areas”, of the final print.

The ink may be transferred directly to a substrate, such as paper, or may be applied to an intermediate surface, such as an offset (or blanket) cylinder in an offset printing system. The offset cylinder may be covered with a conformable coating or sleeve with a surface that can conform to the texture of the substrate, which may have surface peak-to-valley depth somewhat greater than the surface peak-to-valley depth of the imaging plate. Also, the surface roughness of the offset blanket cylinder helps to deliver a more uniform layer of printing material to the substrate free of defects such as mottle. Sufficient pressure is used to transfer the image from the offset cylinder to the substrate. Pinching the substrate between the offset cylinder and an impression cylinder may provide this pressure.

In one variation, referred to as dry or waterless lithography or driography, the plate cylinder is coated with a silicone rubber that is hydrophobic and physically patterned to form the negative of the printed image. A printing material is applied directly to the plate cylinder, without first applying any fountain solution as in the case of the conventional or “wet” lithography process described earlier. The printing material includes ink that may or may not have some volatile solvent additives. The ink is preferentially deposited on the imaging regions to form a latent image. If solvent additives are used in the ink formulation, they may preferentially diffuse towards the surface of the silicone rubber, thus forming a release layer that may reject the printing material. The low surface energy of the silicone rubber adds to the rejection of the printing material. The latent image may again be transferred to a substrate, or to an offset cylinder and thereafter to a substrate, as described above.

The above-described inkjet and lithographic printing techniques may have certain disadvantages. For example, one disadvantage encountered in attempting to modify conventional lithographic systems for variable printing is a relatively low transfer efficiency of the inks off of the imaging plate or belt. For example, in some instances, about half of the ink that is applied to the “reimageable” surface actually transfers to the image receiving media substrate requiring that the other half of the ink be cleaned off the surface of the plate or belt and removed. This relatively low efficiency compounds the cleaning problem in that a significant amount of cleaning may be required to completely wipe the surface of the plate or belt clean of ink so as to avoid ghosting of one image onto another in variable data printing using a modification of conventional lithographic techniques.

Also, unless the ink can be recycled without contamination, the effective cost of the ink is doubled. Traditionally, however, it is very difficult to recycle the highly viscous ink, thereby increasing the effective cost of printing and adding costs associated with ink disposal. Proposed systems fall short in providing sufficiently high transfer ratios to reduce ink waste and the associated costs. A balance must therefore be struck in the composition of the ink to provide optimum spreading on a plate or belt surface including adequate separation between printing and non-printing areas and an increased ability to transfer to a substrate.

Various approaches have been investigated to provide potential solutions to balance the above-mentioned challenges. Those approaches include, for example, blanket material selection, ink design, and auxiliary fluid methods. With respect to material selection, materials that are known to provide optimum release properties include the classes of silicone, fluorosilicone, a fluoropolymer, such as Teflon®, Viton®, and certain hybrid materials. Those materials may have a relatively low surface energy, but may provide poor wetting. Alternatively, polyurethane and polyimide have been used to improve wetting, but at the cost of ink release properties. Tuning ink compositions to address these challenges has proven to be very difficult since the primary performance attribute of the ink is the performance in the print head. For instance, if the ink surface tension is too high it may not jet properly. If, however, the ink surface tension is too low, it will drool out of the face plate of the print head.

Accordingly, identifying and developing new solutions to the competing problem of surface free energy of the blanket so as to improve wet image quality and/or image transfer would be considered a welcome advance in the art.

One possible solution that has been proposed is applying a sacrificial wetting enhancement coating, such as a starch coating, onto the blanket, as disclosed in co-pending Xerox application 20130438-US-NP. However, there may be many disadvantages to using a starch. First, the physical robustness of starch film may be poor. Therefore, the potential problem of contamination exists after the starch film has been transferred onto the prints. Second, the shelf life of the starch may be short. The starch solution degrades quickly and may degrade after just a few days. Even with the use of biocide, the lifetime of the starch solution may only be a few weeks. It is therefore desirable to develop and identify new polymer compositions with good hydrophilic properties and longer shelf life that may find use as sacrificial coating compositions for indirect printing processes.

### SUMMARY

Disclosed herein are sacrificial coating compositions comprising at least one polymer selected from the group consisting of (i) polyvinyl alcohol and (ii) a copolymer of vinyl alcohol and alkene monomers; a wax emulsion comprising at least one wax; at least one hygroscopic agent; at least one surfactant; and water. In certain embodiments, the at least one wax may be chosen from paraffin waxes, polyethylene waxes, polypropylene waxes, microcrystalline waxes, polyolefin waxes, montan based ester waxes and carnauba waxes, and may have a melting point ranging from about 50° C. to about 150° C. The wax emulsion may have a viscosity ranging from about 5 cps to about 200 cps at about 25° C., and a solids content ranging from about 10% to about 50%.

In certain exemplary embodiments, the sacrificial coating composition disclosed herein may comprise at least one hygroscopic material that is chosen from glycerol, glycerin, sorbitol, and glycols such as polyethylene glycol, and at least one non-ionic surfactant that has an HLB value ranging from about 4 to about 14. Moreover, the at least one polymer selected from the group consisting of (i) polyvinyl alcohol and (ii) a copolymer of vinyl alcohol and alkene monomers may have a degree of hydrolysis less than about 95%, and in certain embodiments the copolymer of vinyl alcohol and alkene monomers may be poly(vinyl alcohol-co-ethylene).

Also disclosed herein is a blanket material suitable for transfix printing comprising (1) a first substrate comprising at least one of polysiloxane rubber and fluorinated polymers; and (2) a second substrate on top of the first substrate comprising a sacrificial coating comprising at least one polymer selected from the group consisting of (i) polyvinyl alcohol and (ii) a copolymer of vinyl alcohol and alkene monomers; a wax emulsion comprising at least one wax; at least one surfactant; at least one hygroscopic agent; and water.

Further disclosed herein is an indirect printing process comprising the steps of (1) providing an ink composition to an inkjet printing apparatus comprising an intermediate transfer member; (2) applying a sacrificial coating composition onto the intermediate transfer member, wherein the sacrificial coating composition comprises at least one polymer selected from the group consisting of (i) polyvinyl alcohol and (ii) a copolymer of vinyl alcohol and alkene monomers; a wax emulsion comprising at least one wax; at least one surfactant; at least one hygroscopic agent; and water; (3) dry or semi-dry the sacrificial coating (4) ejecting droplets of ink in an imagewise pattern onto the sacrificial coating composition; (5) at least partially drying the ink to form an ink pattern on the intermediate transfer member; and (6) transferring the ink pattern and the sacrificial coating composition from the intermediate transfer member to a substrate. In certain embodiments the substrate is paper, and in certain embodiments the ink pattern comprises less than about 10% water or solvent, based on the total weight of the dry ink.

Also disclosed herein is an indirect printing process wherein the sacrificial coating composition is applied onto the intermediate transfer member at a temperature below the melting point of the at least one wax in the wax emulsion. In certain embodiments disclosed herein, the ink is at least partially dried to form an ink pattern on the intermediate transfer member at a temperature above the melting point of the at least one wax in the wax emulsion. In certain embodiments, the at least partially dried ink pattern and the sacrificial coating composition are transferred to a substrate at a temperature above the softening point of a resin in the ink.

Both the foregoing general summary and the following detailed description are exemplary only and are not restrictive of the disclosure.

### BRIEF DESCRIPTION OF THE DRAWINGS

FIG. 1A is an optical microscope image taken on film that was coated on G621 blanket substrate with Sample b prepared as described in Example A of the present disclosure.

FIG. 1B is an optical microscope image taken on film that was coated on G621 blanket substrate with Sample c prepared as described in Example A of the present disclosure.

FIG. 2A is a photograph of Sample b of Example A of the present disclosure at a transfer temperature of 100° C., wherein the top image is the blanket after transfer, and the bottom image is the Digital Color Elite Gloss (“DCEG”) paper after the ink has been transferred.

FIG. 2B is a photograph of Sample a (control) of Example A of the present disclosure at a transfer temperature of 100° C., wherein the top image is the blanket after transfer, and the bottom image is the DCEG paper after the ink has been transferred.

FIG. 2C is a photograph of Sample b of Example A of the present disclosure at a transfer temperature of 110° C., wherein the top image is the blanket after transfer, and the bottom image is the DCEG paper after the ink has been transferred.

FIG. 2D is a photograph of Sample a (control) of Example A of the present disclosure at a transfer temperature of 110° C., wherein the top image is the blanket after transfer, and the bottom image is the DCEG paper after the ink has been transferred.

FIG. 3A is an optical microscope image at 5× taken on film that was coated on G621 blanket substrate with Sample 9 prepared as described in Example B of the present disclosure.

FIG. 3B is an optical microscope image at 10× taken on film that was coated on G621 blanket substrate with Sample 9 prepared as described in Example B of the present disclosure.

FIG. 3C is an optical microscope image at 5× taken on film that was coated on G621 blanket substrate with Sample 10 prepared as described in Example B of the present disclosure.

FIG. 3D is an optical microscope image at 10× taken on film that was coated on G621 blanket substrate with Sample 10 prepared as described in Example B of the present disclosure.

FIG. 4A is a photograph of Sample 9 of Example B of the present disclosure at a transfer temperature of 100° C., wherein the top image is the blanket after transfer, and the bottom image is the DCEG paper after the ink has been transferred.

FIG. 4B is a photograph of Sample 9 of Example B of the present disclosure at a transfer temperature of 110° C., wherein the top image is the blanket after transfer, and the bottom image is the DCEG paper after the ink has been transferred.

FIG. 4C is a photograph of Sample 9 of Example B of the present disclosure at a transfer temperature of 120° C., wherein the top image is the blanket after transfer, and the bottom image is the DCEG paper after the ink has been transferred.

FIG. 4D is a photograph of Sample 10 of Example B of the present disclosure at a transfer temperature of 100° C., wherein the top image is the blanket after transfer, and the bottom image is the DCEG paper after the ink has been transferred.

FIG. 4E is a photograph of Sample 10 of Example B of the present disclosure at a transfer temperature of 110° C., wherein the top image is the blanket after transfer, and the bottom image is the DCEG paper after the ink has been transferred.

FIG. 4F is a photograph of Sample 10 of Example B of the present disclosure at a transfer temperature of 120° C., wherein the top image is the blanket after transfer, and the bottom image is the DCEG paper after the ink has been transferred.

### DETAILED DESCRIPTION

Disclosed herein are sacrificial coating compositions comprising at least one polymer selected from the group consisting of (i) polyvinyl alcohol and (ii) a copolymer of vinyl alcohol and alkene monomers; at least one hygroscopic material; at least one surfactant; at least one species of wax emulsion; and water. In certain embodiments, the at least one wax emulsion has a melting point approaching but just below the ink transfer temperature, such as, for example, less than about 150° C., less than about 120° C., less than about 80° C., or less than about 60° C.

The embodiments disclosed herein have good wettability on a fluorinated polymer substrate, good ink holding, wetting and spreading properties, as well as further improved transfer properties.

A typical sacrificial coating composition as disclosed herein may comprise at least one polymer selected from the group consisting of (i) polyvinyl alcohol and (ii) a copolymer of vinyl alcohol and alkene monomers and at least one wax emulsion dispersed in the sacrificial coating composition at a volume fraction of about 50% or less compared to the binder, such as about 45% or less, about 40% or less, or about 35% or less.

Further disclosed herein are processes for coating a blanket with a sacrificial coating composition comprising at least one polymer selected from the group consisting of (i) polyvinyl alcohol and (ii) a copolymer of vinyl alcohol and alkene monomers; at least one hygroscopic material; at least one surfactant; and a wax emulsion comprising at least one wax, such as, for example, transfix print processes using a blanket. In certain embodiments, the preparation of sacrificial coating compositions as disclosed herein comprising a wax emulsion comprising at least one wax involves at least three steps: preparation of the wax emulsion; preparation of the sacrificial coating composition; and coating of the sacrificial coating composition on a blanket, such as a fluorosilicone blanket.

In certain embodiments of the processes disclosed herein, the sacrificial coating composition on the blanket may be dried at a temperature below the melting point of the wax. An image may then be formed in ink, for example digitally, on the sacrificial coating composition that is coating the blanket, and the ink image may be dried at a temperature above the melting point of the wax. Finally, the ink image may be transferred from the coated blanket to a substrate at a temperature optionally above the softening point of the resin used in the ink. In certain embodiments the ink image may be transferred from the coated blanket to a substrate at a temperature greater than about 60° C., such as about 80° C., about 100° C., about 120° C., or about 150° C.

As used herein, a reference to a dried layer or dried coating refers to a hydrophilic continuous uniform film after all or a substantial portion of the liquid carrier has been removed from the composition through a drying process. As described herein, an indirect inkjet printer forms a layer of a hydrophilic composition on a surface of an intermediate transfer member using a liquid carrier, such as water, to apply a layer of the hydrophilic composition. The liquid carrier is used as a mechanism to convey the hydrophilic composition to an image receiving surface to form a uniform layer of the hydrophilic composition on the image receiving surface.

Initially, the sacrificial coating composition is applied to an intermediate transfer member, where it is dried or semi-dried to form a solid-like (or tacky) film. The coating can have a higher surface energy and/or be more hydrophilic than the base intermediate transfer member, which is usually a material with low surface free energy, such as, for example, a polysiloxane, such as polydimethylsiloxane or other silicone rubber material, fluorosilicone, Teflon®, polyimide or combinations thereof.

The drying process may increase the viscosity of the aqueous ink, which changes the consistency of the aqueous ink from a low-viscosity liquid to a higher viscosity tacky material. The drying process may also reduce the thickness of the ink. In certain embodiments, the drying process may remove sufficient water so that the ink contains less than about 10% water or other solvent by weight, such as less than about 2% water, or even less than about 1% water or other solvent, by weight of the ink.

In certain embodiments disclosed herein, the sacrificial coating composition may be made by mixing the ingredients comprising at least one polymer selected from the group consisting of (i) polyvinyl alcohol and (ii) a copolymer of vinyl alcohol monomers and ethylene monomers; at least one hygroscopic material; at least one surfactant; and at least one species of wax emulsion.

The ingredients of the sacrificial coating can be mixed in any suitable manner to form a composition that can be coated onto the intermediate transfer member. In addition to the ingredients discussed above, the mixture can include other ingredients, such as solvents and biocides. Example biocides may include Acticides® CT, Acticides® LA 1209, and Acticides® MBS in any suitable concentration, such as from about 0.1 weight percent to about 2 weight percent. Examples of suitable solvents may include water, isopropanol, MEK (methyl ethyl ketone), and mixtures thereof.

The ingredients can be mixed in any suitable amounts. For example, the at least one polymer chosen from (i) polyvinyl alcohol and (ii) copolymers of vinyl alcohol and alkene monomers can be added in an amount ranging from about 0.5% to about 30%, or from about 1% to about 10%, or from about 1.5% to about 5%, by weight based upon the total weight of the coating mixture. The at least one surfactant can be present in an amount ranging from about 0.1% to about 4%, or from about 0.3% to about 2%, or from about 0.5% to about 1%, by weight based upon the total weight of the coating mixture. The at least one hygroscopic material can be present in an amount ranging from about 0.5% to about 30%, or from about 5% to about 20%, or from about 10% to about 15%, by weight based upon the total weight of the coating mixture.

The compositions of the present disclosure can be used to form a sacrificial coating over any suitable substrate. Any suitable coating method can be employed, including, but not limited to, dip coating, spray coating, spin coating, flow coating, stamp printing, die extrusion coatings, flexo and gravure coating and/or blade techniques. In exemplary embodiments, suitable methods can be employed to coat the liquid sacrificial coating composition on an intermediate transfer member, such as, for example, use of an anilox roller; or an air atomization device, such as an air brush or an automated air/liquid sprayer can be used for spray coating. In another example, a programmable dispenser can be used to apply the coating material to conduct a flow coating.

In certain embodiments disclosed herein, the sacrificial coating composition can first be applied or disposed as a wet coating on the intermediate transfer member. In certain embodiments, the sacrificial coating composition is applied onto the intermediate transfer member at a temperature below the melting point of the at least one wax in the wax emulsion. A drying or curing process can then be employed. In certain embodiments, the wet coating can be heated at an appropriate temperature for the drying and curing, depending on the material or process used. For example, the wet coating can be heated to a temperature ranging from about 30° C. to about 200° C. for about 0.01 seconds to about 100 seconds, such as from about 0.1 second to about 60 seconds. In certain exemplary embodiments, after the drying and curing process, the sacrificial coating can have a thickness ranging from about 0.01 micrometer to about 10 micrometers, such as from about 0.02 micrometer to about 5 micrometers, or from about 0.05 micrometer to about 1 micrometers.

In an embodiment, the sacrificial coating can cover a portion of a major surface of the intermediate transfer member. The major outer surface of the intermediate transfer member can comprise, for example, polysiloxanes, fluoro-silicones, fluoropolymers such as Viton®, Teflon®, and the like.

It has been found that the sacrificial coating composition disclosed herein may overcome the wet image quality problem discussed above by providing an ink wetting surface on the intermediate transfer member. The sacrificial coating compositions may also improve the image cohesion significantly to enable excellent image transfer.

According to certain embodiments, the wax in the at least one wax emulsion can be chosen, for example, from paraffin waxes, polyethylene waxes, oxidized polyethylene waxes, ethylene copolymer waxes, montan based ester waxes, polyether waxes, poly(methylene), polypropylene waxes, microcrystalline waxes, polyolefin waxes, paraffin-ethylene acrylic acid copolymer waxes, carnauba waxes, Fischer Tropsch waxes, and the mixtures thereof. Examples of wax emulsions may include nonionic polyethylene wax emulsions (such as Michem® Emulsion 18325), anionic carnauba wax emulsions (such as Michem® Emulsion 24414), anionic paraffin-ethylene acrylic acid wax emulsions (such as Michem® Emulsion 34935), anionic paraffin-polyethylene wax emulsions (such as Michem® Emulsion 36840), nonionic polyethylene wax emulsions (such as Michem® Emulsion 45745P), nonionic microcrystalline wax emulsions (such as Michem® Emulsion 48040M2), anionic polyethylene wax emulsions (such as Michem® Emulsion 52830), water-based emulsions of montan-based ester waxes (such as Michem® Emulsion 61222), anionic paraffin/polyethylene wax emulsions (such as Michem® Emulsion 66035), nonionic polyethylene wax emulsions (such as Michem® Emulsion 72040), nonionic HD polyethylene/paraffin wax emulsions (such as Michem® Emulsion 91840), and nonionic Fischer Tropsch wax emulsions (such as Michem® Emulsion 98040M1). In certain embodiments, paraffin wax emulsions (such as Aquacer® 498 from BYK) and polyethylene wax emulsions (such as Aquacer® 501, 513, 531 and 552 and Joncryl® wax 26) may be used, as well as paraffin-polyethylene wax emulsions (such as Joncryl® wax 120 from BASF) and paraffin-polyethylene wax emulsions (such as Joncryl® wax 28).

The waxes in the wax emulsion may have different molecular weights, wherein the average weight molecular weight (Mw) can range from about 700 to about 10,000, and the melting points may range from about 50° C. to about 180° C. The dry waxes loading level may in certain embodiments be below about 5% solids content, by weight relative to the weight of the total composition.

The wax emulsions may be non-ionic, cationic or anionic emulsions. The solid content or non-volatile content may range from about 10% to about 50%. The viscosity of the wax emulsion may range from about 5 cps to about 400 cps at about 25° C., such as about 5 cps to about 200 cps (Brookfield LVF #2 spindle, 30 rpm). The pH of the wax emulsion may range from about 3 to about 10, such as from about 6 to about 8. The D₅₀ particle size of the wax emulsion may range from about 10 nm to about 1000 nm, or 20 nm to 500 nm. The melting point of the wax in wax emulsion may range from about 50° C. to about 150° C. The melting point of the wax may in certain embodiments range, for example, from about 50° C. to more than about 100° C.

In certain embodiments, the wax congealing point may be above the release layer temperature set point (such as about 50° C.). In certain embodiments, the wax may also have a sharp melting point so as to be able to fine-tune the transfer temperature setting.

The polyvinyl alcohol (PVOH) and copolymers thereof can act as a binder in the compositions of the present disclosure. In an embodiment, the at least one polymer is polyvinyl alcohol. In an embodiment, the at least one polymer is a copolymer of polyvinyl alcohol and alkene monomers. Examples of suitable polyvinyl alcohol copolymers include poly(vinyl alcohol-co-ethylene). In an embodiment, the poly(vinyl alcohol-co-ethylene) may have an ethylene content ranging from about 5 mol % to about 30 mol %. Other examples of polyvinyl copolymer include poly(acrylic acid)-poly(vinyl alcohol) copolymer, polyvinyl alcohol-acrylic acid-methyl methacrylate copolymer, poly(vinyl alcohol-co-aspartic acid) copolymer, etc.

According to certain embodiments, the degree of hydrolysis of the at least one polyvinyl alcohol may range from about 75% to about 95%, such as, for example about 80% to about 90%, or about 85% to about 88%. The nominal molecular weight of the at least one polyvinyl alcohol may range from about 8,000 to about 30,000. The polyvinyl copolymers may be, for example, poly(vinyl alcohol-co-ethylene) with an ethylene content ranging from about 5 to about 30 mole %. The viscosity of a 4% polyvinyl alcohol solution at 20° C. may range from about 3 cps to about 30 cps.

Polyvinyl alcohol may be manufactured by hydrolysis of polyvinyl acetate from partially hydrolyzed (about 87% to about 89%), intermediate hydrolyzed (about 91% to about 95%), fully hydrolyzed (98% to about 98.8%), or super hydrolyzed (more than about 99.3%). In certain exemplary embodiments, the polyvinyl alcohol employed in the compositions of the present disclosure has a hydrolysis degree ranging from about 75% to about 95%, such as about 85% to about 90%, or about 87% to about 89%.

The polyvinyl alcohol or copolymer thereof can have any suitable molecular weight. In an embodiment, the weight average molecular weight ranges from about 8,000 to about 50,000, such as from about 10,000 to about 40,000, or from about 13,000 to about 23,000.

In an embodiment, the polyvinyl alcohol can provide a suitable viscosity for forming a sacrificial coating on an intermediate transfer member. For example, at about 4% by weight polyvinyl alcohol in a solution deionized water, at 20° C. the viscosity can range from about 2 cps to about 30 cps, such as about 3 cps to about 15 cps, or about 3 cps to about 5 cps, where the % by weight is relative to the total weight of polyvinyl alcohol and water.

The mechanical properties of polyvinyl alcohol may, in certain embodiments, be improved when compared with starches. Moreover, polyvinyl alcohol is a hydrophilic polymer and has good water retention properties. As a hydrophilic polymer, the coating film formed from polyvinyl alcohol exhibits excellent water retention properties, and thus assists the ink spreading on a blanket. Because of its superior spreading, the coatings formulated with polyvinyl alcohol may achieve a significant reduction in total solid loading level. This may provide substantial cost savings while providing an improvement of the coating film performance. In addition, the shelf life of polyvinyl alcohol based formulations is excellent, and polyvinyl alcohol is also considered to be environmentally friendly.

As a hydrophilic polymer, polyvinyl alcohol exhibits excellent water retention properties. In certain embodiments, it is envisioned that low viscosity grades of polyvinyl alcohol, such as Sekisui® Celvol 103, 107, 502, 203 and 205 polyvinyl alcohols, may be used, as they may provide optimum coating rheology. Table 1 below lists certain exemplary polyvinyl alcohols that may be used according to certain embodiments of the sacrificial coating compositions disclosed herein.

TABLE 1
PVOH Properties supplied from Sekisui

| | | | pH |
|---|---|---|---|
| | | Viscosity (cps) | (4% solution |
| Grade | Hydrolysis (%) | (4% solution @ 20° C.) | @ 20° C.) |
| Celvol 103 | 98-98.8 | 3.5-4.5 | 5.0-7.0 |
| Celvol 107 | 98-98.8 | 5.5-6.6 | 5.0-7.0 |
| Celvol 203 | 87-89 | 3.5-4.5 | 4.5-6.5 |
| Celvol 205 | 87-89 | 5.2-6.2 | 4.5-6.5 |
| Celvol 310 | 98-98.8 | 9.0-11.0 | 5.0-7.0 |
| Celvol 418 | 91-93 | 14.5-19.5 | 4.5-7.0 |
| Celvol 502 | 87-89 | 3.0-3.7 | 4.5-6.5 |
| Celvol 513 | 86-89 | 13-15 | 4.5-6.5 |
| Celvol 523 | 87-89 | 23-27 | 4.5-6.5 |

Other polyvinyl copolymers that may be envisioned include poly(vinyl alcohol-co-ethylene) with an ethylene content ranging from about 1 to about 30 mole %.

The chemical structure of the polyvinyl alcohol containing coating composition can be tailored to fine-tune the wettability and release characteristics of the sacrificial coating from the underlying intermediate transfer member surface. This can be accomplished by employing one or more hygroscopic materials and one or more surfactants in the coating composition.

Any suitable hygroscopic material can be employed. Hygroscopic materials can include substances capable of absorbing water from their surroundings, such as humectants. In an embodiment, the hygroscopic material can be a compound that is also functionalized as a plasticizer. Accordingly, as used herein, the term “hygroscopic plasticizer” refers to a hygroscopic material that has been functionalized and can be characterized as a plasticizer. In certain embodiments, the at least one hygroscopic material may be a hygroscopic plasticizer chosen from glycerol/glycerin, sorbitol, xylitol, maltito, polymeric polyols such as polydextrose, glyceryl triacetate, vinyl alcohol, glycols such as propylene glycol, hexylene glycol, butylene glycol, urea, and alpha-hydroxy acids (AHAs). In certain embodiments disclosed herein, the at least one hygroscopic material may be selected from the group consisting of glycerol, sorbitol, glycols such as polyethylene glycol, and mixtures thereof. A single hygroscopic material can be used. Alternatively, multiple hygroscopic materials, such as two, three or more hygroscopic materials, can be used.

Any suitable surfactants can be employed. Examples of suitable surfactants include anionic surfactants, cationic surfactants, non-ionic surfactants and mixtures thereof. The non-ionic surfactants can have an HLB value ranging from about 4 to about 14. A single surfactant can be used. Alternatively, multiple surfactants, such as two, three or more surfactants, can be used. For example, a mixture of a low HLB non-ionic surfactant with a value from about 4 to about 8 and a high HLB non-ionic surfactant with value from about 10 to about 14 demonstrates good wetting performance may be used.

A number of surfactants can be used in the processes disclosed herein. Excess surfactant used for preparing wax dispersions may play a role in the wetting properties of the sacrificial coating formulations disclosed herein. In some embodiments, the at least one surfactant used to make the wax dispersion may be the same as the at least one surfactant used in the sacrificial coating composition and/or the ink itself. In some embodiments, the at least one surfactant used to make the wax dispersion may be different from the at least one surfactant used in the sacrificial coating composition and/or the ink itself. Suitable surfactants may include anionic, non-ionic, and cationic surfactants. In certain embodiments, at least one anionic surfactant may be used, such as sodium lauryl sulfate (SLS), Dextrol OC-40, Strodex tredox PK 90, ammonium lauryl sulfate, potassium lauryl sulfate, sodium myreth sulfate and sodium dioctyl sulfosuccinate. In certain embodiments, at least one non-ionic surfactant may be used, such as Surfynol 104 series, Surfynol 400 series, Dynol 604, Dynol 810, Envirogem® 360, secondaryl alcohol ethoxylate series such as Tergitol® 15-s-7, Tergitol® 15-s-9, TMN-6, TMN-100x, and Tergitol® NP-9, and Triton X-100, etc. In certain embodiments, cationic surfactants may be used, such as Chemguard S-106A, Chemguard S-208M, and Chemguard S-216M. Fluorinated or silicone surfactants can be used in certain embodiments, such as, for example, PolyFox® TMPF-136A, 156A, and 151 N, Chemguard S-761p and S-764p, Silsurf® A008, Siltec C-408, BYK 345, 346, 347, 348, and 349, and polyether siloxane copolymers, such as TEGO Wet-260, 270, and 500, etc. Some amphoteric fluorinated surfactants are also envisioned for use in certain embodiments, such as, for example, alkyl betaine fluorosurfactants and alkyl amine oxide fluorosurfactants, such as Chemguard S-500 and Chemguard S-111. Table 2 below lists exemplary surfactants that may be considered for use in both the wax dispersions and/or the sacrificial coating compositions disclosed herein.

TABLE 2

| | | | | | | Petroleum | | | | |
|---|---|---|---|---|---|---|---|---|---|---|
| | | | | | | Ether | Alcohol | | | Free |
| | | | | | Active | Soluble | Insoluble | Water | | Sulfonic |
| | | | | Chemical | Ingredient | Matter | Matter | Content | | Acid |
| Series | Grade | Function | Type | Name | (%) | (%) | (%) | (%) | pH | (%) |
| Tayca- | N4133 | Forming | Natural | Sodium | 33.0 ± 1.0 | 1.0≧ | 2.0≧ | 68.0≧ | 7.5-9.5 | — |
| lite | | cleansing | alcohol | higher | | | | | | |
| | | emulsification/ | | alcohol | | | | | | |
| | | dispersion | | sulfate | | | | | | |
| | | permeation/ | | | | | | | | |
| | | penetration | | | | | | | | |
| Tayca- | NE1230 | Forming | Natural | Sodium | 27.0 ± 1.0 | 1.0≧ | 1.0≧ | 74.0≧ | 6.0-8.0 | — |
| pol | NE1270 | cleansing | alcohol | higher | 70.0 ± 2.0 | 3.0≧ | 3.0≧ | 32.0≧ | 6.0-8.0 | — |
| | NE1325 | emulsification/ | | alcohol | 25.5 ± 1.5 | 1.0≧ | 1.0≧ | 76.0≧ | 6.0-8.0 | — |
| | NE1370 | dispersion | | ethoxysulfate | 70.0 ± 2.0 | 2.8≧ | 3.0≧ | 32.0≧ | 6.5-8.8 | — |
| | NE7030 | permeation/ | Synthetic | | 27.0 ± 1.0 | 1.0≧ | 1.0≧ | 74.0≧ | 6.0-8.0 | — |
| | | penetration | alcohol | | | | | | | |
| Tayca- | B120 | Forming | Hard | Dodecylbenzene | 96.0≦ | 3.0≧ | — | — | — | 0.8≧ |
| power | B121 | cleansing | (branched | sulfonic acid | 96.0≦ | 2.5≧ | — | 1.0≧ | — | 1.5≧ |
| | BN2060 | emulsification/ | alkyl) | Sodium | 60.0 ± 2.0 | 2.0≧ | 1.5≧ | 40.50≧ | 6.0-8.0 | — |
| | | dispersion | | dodecylbenzene | | | | | | |
| | | permeation/ | | sulfonate | | | | | | |
| | | penetration | | | | | | | | |
| | BN2070M | Emulsification/ | | | *70.0≦ | — | — | 3.0≧ | 6.0-8.0 | — |
| | BC2070M | dispersion | | Calcium | *70.0≦ | — | — | 3.0≧ | 6.0-8.0 | — |
| | | permeation/ | | dodecylbenzene | | | | | | |
| | | penetration | | sulfonate | | | | | | |
| | | Solubilization | | | | | | | | |
| | L120D | Forming | Soft | Dodecylbenzene | 96.0≦ | 2.5≧ | — | 1.0≧ | — | 1.5≧ |
| | L121 | cleansing | (linear | sulfonate | 96.0≦ | 2.5≧ | — | 1.0≧ | — | 1.5≧ |
| | L124 | emulsification/ | alkyl) | | 96.0≦ | 2.5≧ | — | 1.0≧ | — | 1.5≧ |
| | LN2050D | dispersion | | Sodium | 50.0 ± 2.0 | 1.5≧ | 2.0≧ | 50.0≧ | 6.0-8.0 | — |
| | LN2450 | permeation/ | | dodecylbenzene | 50.0 ± 2.0 | 1.5≧ | 2.0≧ | 50.0≧ | 6.0-8.0 | — |
| | LN2425 | penetration | | sulfonate | 25.0 ± 1.0 | 0.8≧ | 1.0≧ | 75.0≧ | 6.0-8.0 | — |

Also disclosed herein is a blanket material suitable for a transfix printing process comprising a first substrate made of a polysiloxane rubber or fluorinated polymer and a second sacrificial coating comprising a composition comprising at least one polymer selected from the group consisting of (i) polyvinyl alcohol and (ii) a copolymer of vinyl alcohol and alkene monomers; at least one surfactant; at least one hygroscopic material; and a wax emulsion comprising at least one wax.

As disclosed herein, there are certain advantages that may be achieved by embodiments disclosed herein over processes known in the art. For example, sacrificial coating compositions comprising at least one wax emulsion as disclosed herein may improve the performance of the sacrificial layer in transfuse printing processes. Moreover, the ability to improve performance may result in lowering process costs. According to certain transfer processes disclosed herein, the sacrificial coating compositions may allow for independent control of rheological properties at the transfer temperature, as well as a higher solid loading of the sacrificial composition layer with a minimum increase in the viscosity. According to certain transfer processes disclosed herein, the sacrificial coating compositions may allow for improved release properties from the transfer intermediate member through the selection of appropriate wax/surfactant dispersion and transfer temperature and control of transfer temperature with the appropriate selection of melting point of the wax.

Unless otherwise indicated, all numbers used in the specification and claims are to be understood as being modified in all instances by the term “about,” whether or not so stated. It should also be understood that the precise numerical values used in the specification and claims form additional embodiments of the disclosure, as do all ranges and sub-ranges within any specified endpoints. Efforts have been made to ensure the accuracy of the numerical values disclosed in the measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary.

It is to be understood that both the foregoing description and the following example are exemplary and explanatory only and are not intended to be restrictive. In addition, it will be noted that where steps are disclosed, the steps need not be performed in that order unless explicitly stated.

The accompanying figures, which are incorporated in and constitute a part of this specification, are not intended to be restrictive, but rather illustrate embodiments of the disclosure.

Other embodiments will be apparent to those skilled in the art from consideration of the specification and practice of the disclosure.

### EXAMPLES

The following examples are not intended to be limiting of the disclosure.

### Example A

### Sacrificial Coating with Commercially Available Wax Emulsions

### Example A1

### Commercially Available Wax Emulsion Selections

Various wax emulsions with nano particle sizes were selected and screened for potential application in sacrificial coating compositions. Some of the wax emulsions from BYK and BASF are summarized in Table 3 below.

TABLE 3

| | | | | | | Viscosityat | |
|---|---|---|---|---|---|---|---|
| | | | | | | 25° C. (cps) | |
| | | | Non- | | Particle | (Brookfield | Melting |
| Emulsion | | | volative | | size | LVF #2 | point |
| Wax | Supplier | Wax type | (% solid) | pH | (nm) | spindle, 30 rpm) | (° C.) |
| Aquacer ® | BYK | Paraffin | 50% | 9.0 | >1 micron | <50 | 60 |
| 498 | | | | | | | |
| Aquacer ® | BYK | polyethylene | 35% | 9.0 | <150 | 25 | 130 |
| 501 | | | | | | | |
| Aquacer ® | BYK | polyethylene | 35% | 9.2 | <100 | 60 | 135 |
| 513 | | | | | | | |
| Aquacer ® | BYK | polyethylene | 35% | 9.0 | <100 | 25 | 130 |
| 552 | | | | | | | |
| Aquacer ® | BYK | polyethylene | 45% | 3.5 | <100 | 125 | 125 |
| 531 | | | | | | | |
| Joncryl ® | BASF | paraffin/ | 34% | 9 | 80 | 400 | 56 |
| Wax 120 | | polyethylene | | | | | |
| Joncryl ® | BASF | polyethylene | 25% | 9.8 | 50 | 10 | 130 |
| Wax 26 | | | | | | | |
| Joncryl ® | BASF | paraffin/ | 34% | 9.2 | 80.0 | 50 | 132 |
| Wax 28 | | polyethylene | | | | | |

### Example A2

### Commercially Available Wax Emulsion Particle Size Characterization

The wax emulsion particle size for certain of the wax emulsions was measured using Nanotrac®. The Nanotrac® is a particle size analyzer that is based on Dynamic Light Scattering and has a size measuring range from about 0.8 nm to about 6.5 um.

The particle size for all of the BYK wax emulsions were within about 50 nm to about 150 nm except Aquacer® 498. The particle size results for the Aquacer® wax emulsions from BYK are summarized in Table 4, below.

TABLE 4

| | Aquacer ® | Aquacer ® | Aquacer ® | Aquacer ® | Aquacer ® | Aquacer ® |
|---|---|---|---|---|---|---|
| Property | 498 | 501 | 513 | 535 | 552 | 531 |
| Particle | >1 micron | <150 | <100 | <150 | <100 | <100 |
| size (nm) | | | | | | |

### Example A3

### Sacrificial Coating Composition with Commercially Available Wax Emulsion

Some sacrificial coating compositions were prepared with and without an Aquacer® wax emulsion.

### Example A3-a

The control sacrificial coating solution did not comprise a wax emulsion. It was prepared by mixing 15 g of 10% Celvol PVOH 203 solution and 5 g of glycerol into 79.75 g of deionized water. Next, 0.25 g Tergitol TMN-6 was added into the mixture to make 100 g of solution.

### Example A3-b

One sacrificial coating solution was loaded with 0.5% Aquacer® 531 wax emulsion. It was prepared by mixing 15 g of 10% Celvol PVOH 203 solution, 3 g of glycerol and 0.5 g of Aquacer®531 into 81 g of deionized water. Next, 0.5 g of Tergitol TMN-6 was added into the mixture to make 100 g of solution. The coating solution was very stable over time.

### Example A3-c

Another sacrificial coating solution was prepared with a BASF wax emulsion. It was prepared by mixing 15 g of 10% Celvol PVOH 203 solution, 3 g of glycerol and 0.5 g of Joncryl®28 wax emulsion into 81 g of deionized water. Next, 0.5 g of Tergitol TMN-6 was added into the mixture to make 100 g of solution. The coating solution was very stable over time.

### Example A4

### Coating Process

The sacrificial coating compositions were coated on blanket substrates using Pamarco anilox roll 165Q13 by hand. The substrates were made from fluorinated polymer G621 manufactured by Daikin Industries, Ltd. and a crosslinker, AO700. (aminoethyl aminopropyl trimethoxysilane from Gelest). A hotplate was set up at 60° C. while the substrate temperature was around 50° C. The wet film thickness was about 4 about 5 microns, and the dry film thickness was about 500 nm to about 1500 nm. The coated film was dried in oven at about 60° C. for about 30 seconds.

### Example A5

### Optical Microscope Images—Film Forming Property Evaluation

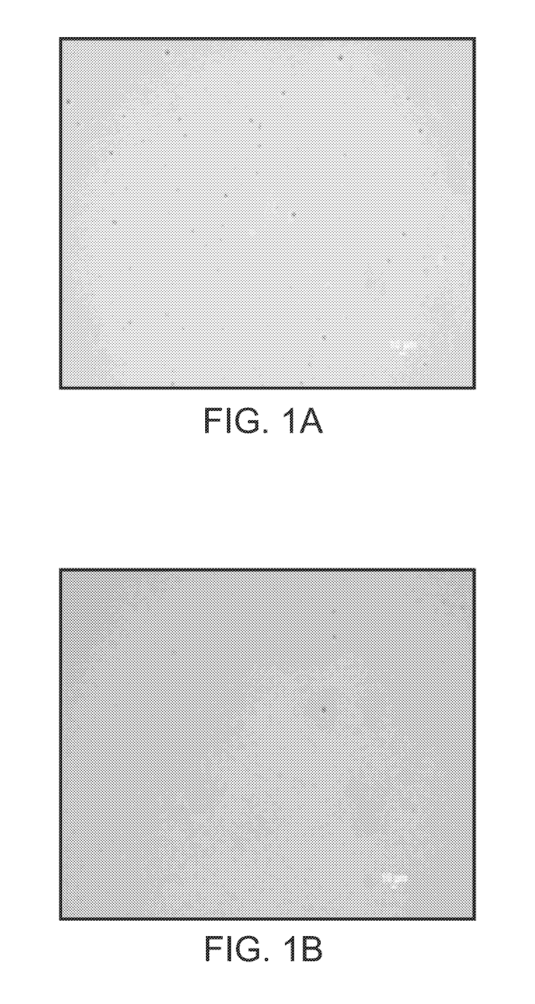

In order to make ink to have good wetting and spreading properties on undercoat film, it may be desirable to achieve continuous uniform film with the sacrificial coating composition. Optical microscope images were taken on the film that was coated on G621 blanket substrate. As shown in FIG. 1B, Sample c forms a continuous uniform film. As shown in FIG. 1A, Sample b has some defects that may come from the blanket on the surface, although the identity of the particles is not known.

### Example A6

### Airbrush Transfer Test

Collins ink PWK-1223 was used for the transfer test. The ink was sprayed on the coated blanket by air brush. The transfer conditions were as follows: 320° F., 50 psi, and 5 seconds dwell time. The ink was transferred from the blanket to 120 gsm Digital Color Elite Gloss paper.

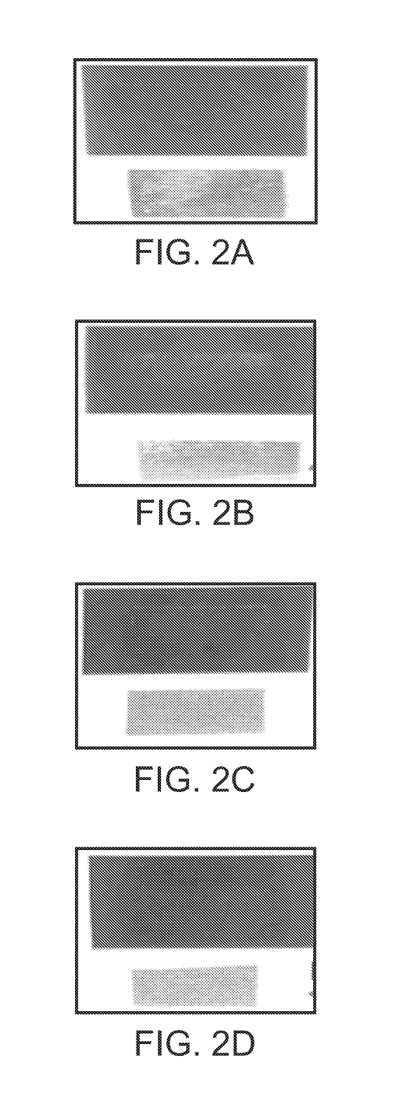

Images were taken to show the transfer results of sacrificial coating composition comprising a wax emulsion versus a sacrificial coating composition comprising TMN-6 surfactant only at different transfer temperatures. In FIGS. 2A-2D, the top images are the blanket after transfer, and the bottom images are the DCEG paper after ink transfer. FIG. 2A shows Sample b at a transfer temperature of 100° C., and FIG. 2C shows Sample b at a transfer temperature of 110° C. FIG. 2B shows Sample a (control) at a transfer temperature of 100° C., and FIG. 2D shows Sample a (control) at a transfer temperature of 110° C.

As can be seen in FIGS. 2A and 2C, there is much less residual ink on the blankets that had been coated with the sacrificial coating composition comprising wax emulsion, and the transfer temperature can be dropped around 20° C. with wax emulsion. A darker image on the DCEG paper corresponds to better ink transfer.

### Example B

### Sacrificial Coating with In-House Prepared Wax Emulsions

### Example B1

### Preparation of Cytech FNP-0080 Wax Dispersion

The process of preparing an aqueous dispersion of a Cytech FNP-0080 wax dispersion was carried out using a 4-litre stainless steel, jacketed and stirred reactor connected to a piston homogenizer.

About 44 g of Tayca BN2060 surfactant was added to about 2000 g of deionized water in a 2 liter plastic bottle and stirred with a spatula until dissolved. About 1060 g of the Cytech FNP-0080 wax was melted in the water containing surfactant under pressure at 120° C.

The slurry containing molten wax was then recirculated through the in-line piston homogenizer operating at a pressure of about 800 psig in a first stage (120° C. for about 20 minutes at 500 rpm) and about 6000 psig in a second stage (120° C. for about 45 minutes at 500 rpm). After recirculating the contents through the homogenizer for a designated number of passes, the contents were cooled down to less than about 50° C., filtered through a 100 micron nylon filter, and discharged as a liquid into a container.

The resultant product was a homogeneous aqueous dispersion containing about 34 weight % wax particles. The formulation of the wax dispersion is shown below in Table 5.

TABLE 5

| Chemical | Weight % | Mass (g) |
|---|---|---|
| Cytech FNP-0080 wax | 34.15 | 1060 |
| Tayca BN2060 | 1.42 | 44 |
| surfactant (60% solids) | | |
| DIW | 64.43 | 2000 |
| Total | 100.00 | 3104 |

### Example B2

### Preparation of Paraffin (IGI 1260A) Wax Emulsion

### Example B2-a

A low congealing point paraffin wax was obtained from IGI and was used to demonstrate the feasibility of embodiments disclosed herein. IGI-1260A has the following physical properties as listed below in Table 6 (INCI name: paraffin).

TABLE 6

| | ASTM | Specifications | | |
|---|---|---|---|---|
| Test Methods | Method | Minimum | Maximum | Typical |
| Congealing point ° F. (° C.) | D 938 | 152 (66.7) | 166 (74.4) | 157 (69.4) |
| Kinematic Viscosity, cSt @ | D 445 | 5.7 | 7.9 | 6.5 |
| 212° F. (100° C.) | | | | |
| Oil content, wt % | D 721 | — | 1.0 | 0.47 |
| Saybolt color | D 6045 | +25 | — | +28 |
| Odor | D 1833 | — | 1 | 0 |
| Needle penetration, | D 1321 | — | 18 | 12 |
| dmm @ 77° F. (25° C.) | | | | |

### Example B2-b

Preparation of IGI 1260A Wax Dispersion. The preparation of the wax dispersion involved melting the wax emulsion prepared above in water at about 120° C., dispersing the molten concentrate with a piston homogenizer, and stabilizing the wax particles formed with a surfactant. The product is a stable aqueous dispersion of wax having an average particle size, D50, of about 150 nm to about 300 nm, with a preferred standard deviation of less than about 10.

The process of preparing an aqueous dispersion of wax was carried out using a 4-litre stainless steel, jacketed and stirred reactor connected to a piston homogenizer.

About 44 g of Tayca BN2060 surfactant was added to about 2000 g of deionized water in a 2 liter plastic bottle and stirred with a spatula until dissolved. About 1060 g of the IGI 1260A wax was melted in the water containing surfactant under pressure at 120° C.

The slurry containing molten wax was then recirculated through the in-line piston homogenizer operating at a pressure of about 800 psig in a first stage (120° C. for about 20 minutes at 500 rpm) and about 6000 psig in a second stage (120° C. for about 45 minutes at 500 rpm). The molten wax concentrate experienced significant shear force when it passed through the ceramic piston inside the homogenizer and was dispersed into particles having a D50 of about 230 nm, with a narrow standard deviation of about 5 to about 6 nm. After recirculating the contents through the homogenizer for a designated number of passes, the contents were cooled down to less than about 50° C., filtered through a 100 micron nylon filter, and discharged as a liquid into a container.

The resultant product was a homogeneous aqueous dispersion containing about 34 weight % wax particles. The formulation of the wax dispersion is shown below in Table 7.

TABLE 7

| Chemical | Weight % | Mass (g) |
|---|---|---|
| IGI 1260A wax | 34.15 | 1060 |
| Tayca BN2060 | 1.42 | 44 |
| surfactant (60% solids) | | |
| DIW | 64.43 | 2000 |
| Total | 100.00 | 3104 |

### Example B3

### Sacrificial Coating Compositions

Compositions were prepared with polyvinyl alcohol as a binder and TMN-6 as a surfactant. Because of the low density of the wax particles, the solutions were expected to be stable and non-settling. The wax dispersion used for making the sacrificial release coating compositions disclosed herein were obtained as described above. Table 8 below describes exemplary sacrificial coating compositions comprising a wax dispersion prepared according to embodiments disclosed herein.

TABLE 8

| | | | | | Sur- | | |
|---|---|---|---|---|---|---|---|
| | | | Cosol- | 34% | factant | | |
| Sam- | PVOH | Starch | vent | Wax dis- | Tergitol | DI | |
| ple | Binder | Binder | glycerol | persion | TMN-6 | Water | Total |
| No. | (%) | (%) | (%) | (%) | (%) | (%) | (%) |
| 1 | 1.5 | 0 | 5 | 1 | 0.25 | 92.25 | 100 |
| 2 | 1.3 | 0 | 5 | 1 | 0.25 | 92.45 | 100 |
| 3 | 1.5 | 0 | 5 | 1 | 0.25 | 92.25 | 100 |
| 4 | 0 | 2.7 | 7 | 1 | 0.25 | 89.05 | 100 |
| 5 | 0 | 2.7 | 7 | 1 | 0.25 | 89.05 | 100 |
| 6 | 2.7 | 0 | 7 | 1 | 0.25 | 89.05 | 100 |
| 7 | 0 | 2.4 | 7 | 1 | 0.25 | 89.35 | 100 |
| 8 | 1.5 | 0 | 5 | 3 | 0.25 | 90.25 | 100 |

Compositions 1 to 3 and 8 were based on mainline polyvinyl alcohol comprising a sacrificial layer, while compositions 4 to 7 were based on an optimum formulation of a sacrificial layer comprising a waxy maize corn starch.

The optimum formulation was obtained through detailed analysis of the wetting and transfer data for the starch sacrificial coating through Design of Experiment (DOE). Optimum set point for best transfer efficiency and acceptable spreading is: total glycerol+starch=9.7% and ratio=2.57. Two of the skin formulation (Samples 1 and 6 in Table 8 above) were selected to demonstrate feasibility of embodiments disclosed herein and define the specifications for best improvements. The formulations are shown below in Table 9.

TABLE 9

| | | Surfactant/Wax | | |
|---|---|---|---|---|
| Sample | Polymer | Emulsion | | |
| ID | Description | Loading (%) | Formulation | Loading Ratio |
| 9 | 10% PVOH | 0.1% Tergitol | 7.5 g 10% PVOH 203 + | 1.5% PVOH 203 |
| | Celvol 203 | TMN-6 | 2.5 g glycerol + 0.05 g | 5% glycerol |
| | | 0.5% IGI-1260A | Tergitol TMN-6 + 0.25 g | 0.1% Tergitol |
| | | | IGI-1260A (wax | TMN-6 |
| | | | emulsion) + 39.7 g DI | 0.5% IGI-1260A |
| | | | water (total = 50 g) | 92.5% DI water |
| 10 | 10% Celvol | 0.25% Tergitol | 13.5 g 10% PVOH 203 + | 2.7% PVOH 203 |
| | PVOH 203 | TMN-6 | 3.5 g glycerol + | 7% glycerol |
| | | 1% IGI-1260A | 0.125 g Tergitol TMN-6 + | 0.25% Tergitol |
| | | | 0.5 g IGI-1260A (wax | TMN-6 |
| | | | emulsion) + 32.375 g | 1% IGI 1260A |
| | | | DI water (total = 50 g) | 92.5% DI water |

### Example B4

### Sacrificial Coating Process and Optical Microscope Images

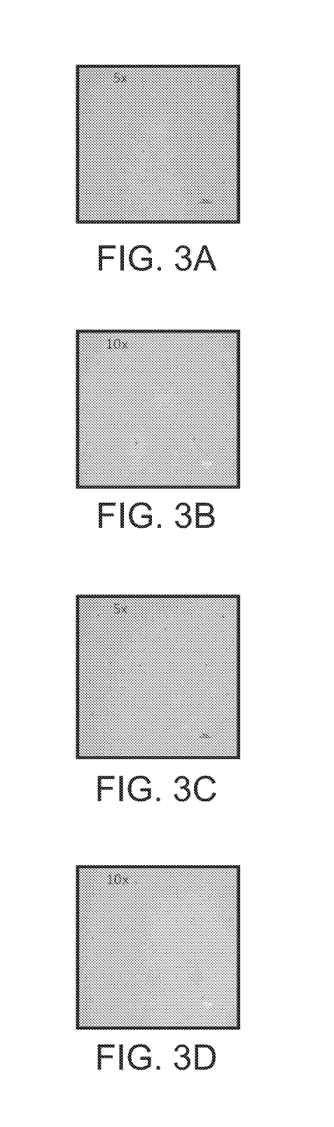

The optical microscope images were taken on the film, which was coated on a G621 blanket substrate before the transfer test. As shown in FIGS. 3A-3D, which show optical microscope images at 5× and 10× for both Samples 9 and 10, respectively, very uniform film was achieved for both formulations.

### Example B5

### Transfer Test

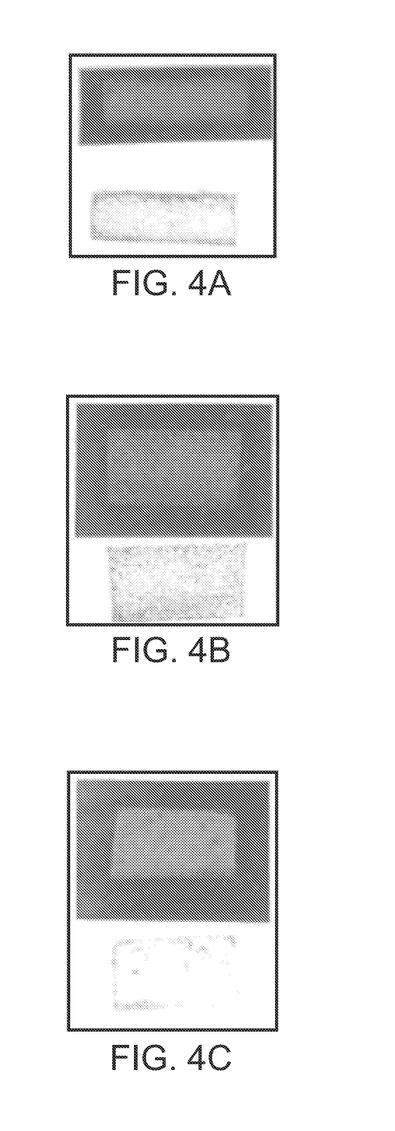

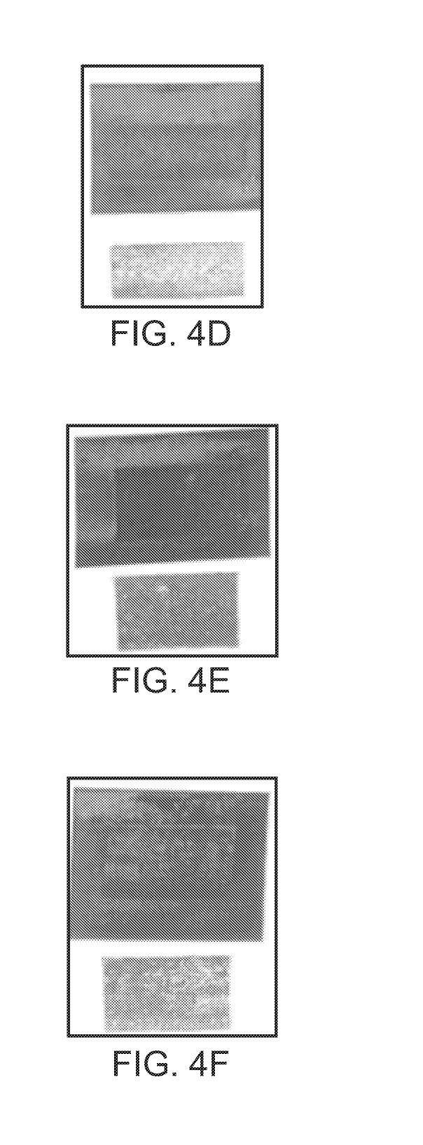

The transfer test process was the same as Example A6. The results are shown in FIGS. 4A-4F.

A dependence of transfer efficiency on the sacrificial coating composition was observed. At low settings of polyvinyl alcohol and wax, there was very poor transfer efficiency at all temperatures tested. On the other hand, the sacrificial coating composition optimized for best transfer efficiency and wetting showed improved transfer efficiency over the full range of temperatures, and, more importantly, transfer efficiency was very high at an optimum temperature. The non-obviousness of certain embodiments was therefore demonstrated.

What is claimed is:

1. An sacrificial coating composition comprising:
at least one polymer selected from the group consisting of i) polyvinyl alcohol and ii) a copolymer of vinyl alcohol and alkene monomers;
a wax emulsion comprising at least one wax;
at least one surfactant;
at least one hygroscopic agent; and
water.

2. The sacrificial coating composition according to claim 1, wherein the at least one wax has a melting point ranging from about 50° C. to about 150° C.

3. The sacrificial coating composition according to claim 1, wherein the solid content of the at least one wax ranges from about 0.1% to about 5% by weight relative to the total composition.

4. The sacrificial coating composition according to claim 1, wherein the at least one wax is selected from paraffin waxes, polyethylene waxes, polypropylene waxes, microcrystalline waxes, polyolefin waxes, montan based ester waxes, carnauba waxes and mixtures thereof.

5. The sacrificial coating composition according to claim 1, wherein the at least one hygroscopic agent is chosen from glycerol, sorbitol, vinyl alcohols, glycols, xylitol, maltitol, polymeric polyols, glyceryl triacetate, urea, alpha-hydroxy acids and mixtures thereof.

6. The sacrificial coating composition according to claim 1, wherein the at least one surfactant is non-ionic surfactant with HLB value ranging from about 4 to about 14.

7. The sacrificial coating composition according to claim 1, wherein the at least one surfactant is sodium lauryl sulfate anionic surfactant.

8. The sacrificial coating composition according to claim 1, wherein the at least one polymer is polyvinyl alcohol having a hydrolysis degree ranging from about 75% to about 95%.

9. The sacrificial coating composition according to claim 1, wherein the at least one polymer is polyvinyl alcohol having a weight average molecular weight ranging from about 8000 to about 30,000.

10. The sacrificial coating composition according to claim 1, wherein the copolymer of vinyl alcohol and alkene monomers is selected from the group consisting of poly(vinyl alcohol-co-ethylene), poly(acrylic acid)-poly(vinyl alcohol) copolymer, polyvinyl alcohol-acrylic acid-methyl methacrylate copolymer, and poly(vinyl alcohol-co-aspartic acid) copolymer.

11. The sacrificial coating composition according to claim 1, wherein the wax emulsion has a viscosity ranging from about 5 cps to about 200 cps at about 25° C.

12. The sacrificial coating composition according to claim 1, wherein the wax emulsion has a pH ranging from about 3 to about 10.

13. The sacrificial coating composition according to claim 1, wherein the wax emulsion has a wax particle size ranging from about 10 nanometers to about 1000 nanometers.

14. A blanket material suitable for transfix printing comprising:
a first substrate comprising at least one of polysiloxane rubber and fluorinated polymers;
a second substrate on top of the first substrate comprising a sacrificial coating comprising at least one polymer selected from the group consisting of i) polyvinyl alcohol and ii) a copolymer of vinyl alcohol and alkene monomers; a wax emulsion comprising at least one wax; at least one surfactant; at least one hygroscopic agent; and water.

15. The blanket material according to claim 14, wherein the at least one wax is selected from paraffin waxes, polyethylene waxes, polypropylene waxes, microcrystalline waxes, polyolefin waxes, montan based ester waxes, carnauba waxes and mixtures thereof.

16. The blanket material according to claim 14, wherein the sacrificial coating has a dry film thickness ranging from about 100 nm to about 2000 nm.

17. An indirect printing process comprising:
providing an ink composition to an inkjet printing apparatus comprising an intermediate transfer member;
applying a sacrificial coating composition onto the intermediate transfer member, wherein the sacrificial coating composition comprises at least one polymer selected from the group consisting of i) polyvinyl alcohol and ii) a copolymer of vinyl alcohol and alkene monomers; a wax emulsion comprising at least one wax; at least one surfactant; at least one hygroscopic agent; and water;
drying the sacrificial coating to a semi-dried or a dried state;
ejecting droplets of ink in an imagewise pattern onto the sacrificial coating composition;
at least partially drying the ink to form an ink pattern on the intermediate transfer member; and
transferring the ink pattern and the sacrificial coating composition from the intermediate transfer member to a substrate.

18. The indirect printing process according to claim 17, wherein the at least one wax is selected from paraffin waxes, polyethylene waxes, polypropylene waxes, microcrystalline waxes, polyolefin waxes, montan based ester waxes, carnauba waxes, and mixtures thereof.

19. The indirect printing process according to claim 17, wherein the at least one polymer is polyvinyl alcohol having a hydrolysis degree ranging from about 75% to about 95%.

20. The indirect printing process according to claim 17, wherein the at least partially dried ink pattern and the sacrificial coating composition are transferred to a substrate at a temperature above the melting point of the at least one wax in the wax emulsion.
